(19) United States
(12) Patent Application Publication
(10) Pub. No.: US 2019/0296554 A1
(43) Pub. Date: Sep. 26, 2019

(54) CONTROL APPARATUS FOR LARGE POWER SUPPLY SYSTEMS HAVING A MULTIPLICITY OF SMALL, DECENTRALIZED AND POSSIBLY VOLATILE PRODUCERS

(71) Applicant: SIEMENS AKTIENGESELLSCHAFT, München (DE)

(72) Inventors: Joachim BAMBERGER, Stockdorf (DE); Michael Bernhard BUHL, Grafing (DE); Ulrich MÜNZ, Plainsboro, NJ (US)

(73) Assignee: Siemens Aktiengesellschaft, München (DE)

(21) Appl. No.: 16/316,368

(22) PCT Filed: Jun. 12, 2017
(86) PCT No.: PCT/EP2017/064211

§ 371 Date: Jan. 9, 2019

(30) Foreign Application Priority Data
Jul. 13, 2016 (DE) 10 2016 212 726.8

(51) Int. Cl. H02J 3/38; H02J 3/14

(52) U.S. Cl. CPC H02J 3/382; H02J 3/14

(57) ABSTRACT

Provided is a control apparatus for determining a secondary/tertiary control power of a particular decentralized producer in a power supply system having a multiplicity of power producers, in which a subtractor is present such that a deviation of the locally measured or estimated frequency from the mains frequency is first of all determined, in which an amplifier is present, downstream of which an integrator with a limiter is connected, which, in addition to integration, ensures that a secondary/tertiary control power formed at the output of an integrator is limited, and in which the amplifier has a dead band, and/or the output of the integrator with the limiter is negatively fed back to the input of the integrator with the limiter via a feedback unit in which multiplication by a factor is carried out.

### CROSS-REFERENCE TO RELATED APPLICATIONS

This application claims priority to PCT Application No. PCT/EP2017/064211, having a filing date of Jun. 12, 2017, based off of German Application No. 10 2016 212 726.8, having a filing date of Jul. 13, 2016, the entire contents both of which are hereby incorporated by reference.

### FIELD OF TECHNOLOGY

The following relates to a control apparatus for large power supply systems having a multiplicity of small, decentralized and possibly volatile producers, in which stable network operation is achieved by means of decentralized formation of a respective secondary/tertiary control output on the part of the individual producers.

### BACKGROUND

For many years, power production has shifted from a few large, plannable and concentrated producers, typically thermal power plants such as gas turbines, coal or nuclear power plants, to many small, decentralized and volatile producers such as wind turbines or photovoltaic systems. The result of this volatile production is that sudden, unforeseen production changes are increasing, which means that the demand for primary and secondary control output is already rising sharply nowadays, and increasingly so in the future. On the other hand, the number of classic suppliers of primary and secondary control output, namely large thermal power plants, is decreasing more and more sharply. This results in an increasing demand for primary and secondary control output provision by small, decentralized and possibly volatile producers.

### SUMMARY

An aspect of the primary control output is to transfer the network into a stable operating state following load and production changes. This often leads to undesired production shifts and a permanent frequency deviation, which means that the network frequency deviates from a nominal frequency of 50 Hz, for example by 0.1 Hz.

The aspect of the secondary control output is to return the network frequency to the nominal frequency again, and to re-balance the distribution of the load and production change between the remaining producers.

Furthermore, a tertiary control output can be used to bring the individual producers as close as possible to their optimal operating point again.

In current power networks with predominantly thermal production, the requisite secondary control output is calculated centrally and distributed to the associated components as production setpoints. This method is very successful, since a central calculation can in principle take all the factors into account.

However, with the increasing number of decentralized producers, a central calculation becomes more and more difficult. Furthermore, only those producers which are known to the control center and can communicate with the control center can supply secondary control output. In the event of a failure of the control center or the communication between the control center and the producers, secondary control output can no longer be provided.

Various publications set a distributed secondary control output concept against this traditional concept, which is based on permanent communication between the producers, see, for example, F. Dörfler, J. W. Simpson-Porco, F. Bullo: Breaking the Hierarchy: Distributed Control & Economic Optimality in Microgrids, arXiv:1401.1767. [Online] 2014. [Cited: 10 27, 2015] http://arxiv.org/pdf/1401.1767v2.pdf.

These concepts can be scaled better on power networks having many producers which provide secondary control output but, once more, have other considerable disadvantages. The failure of even only part of the communication network has considerable effects on the distribution of the secondary control output and, amongst other things, leads to a permanent frequency deviation and thus to a permanent production inequality. New producers which intend to produce secondary control output must be integrated into the existing communication and control structure. Furthermore, it is not clear whether the transition from the current system to this new system is possible without comprehensive reorganization.

The aspect on which embodiments of the invention is based consists in specifying a control apparatus for producing stable, robust and reliable network operation in large power networks having a multiplicity of small, decentralized and possibly volatile producers, in which a respective secondary and tertiary control output on the part of a producer is enabled as far as possible without explicit communication between the producers.

Embodiments of the invention relates substantially to a control apparatus for determining a secondary/tertiary control output of a respective decentralized producer in a power network having a multiplicity of power producers, in which there is a subtractor such that, first of all, a deviation of the locally measured or estimated frequency from the network frequency is determined, in which there is an amplifier, downstream of which there is connected an integrator with limiter which, in addition to integration, ensures that a secondary/tertiary control output formed on the output of an integrator is limited, and in which the amplifier has a dead band and/or the output of the integrator with limiter is fed back negatively to the input of the integrator with limiter via a feedback unit in which multiplication by a factor is carried out.

The advantages of embodiments of the invention lie in virtually arbitrary scalability, wherein an overload of individual participants, for example as a result of saturation, is prevented, in very simple entry into an existing control output pool, in high robustness with respect to network separation of large power networks and with respect to communication failures, wherein the latter is of great importance in particular in emergency scenarios, and in good compatibility with already existing secondary control output structures.

### BRIEF DESCRIPTION

Some of the embodiments will be described in detail, with references to the following Figures, wherein like designations denote like members, wherein:

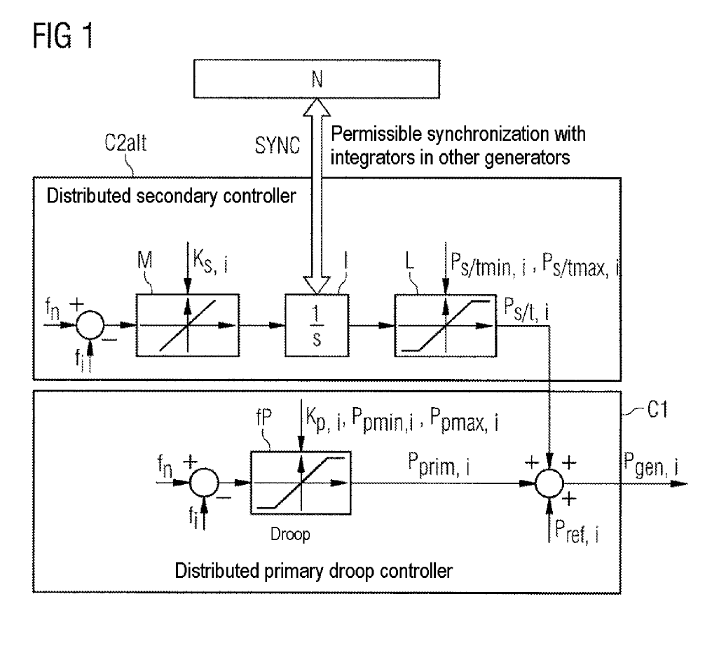

FIG. 1 shows a basic circuit diagram of a known control apparatus for the decentralized production of a primary and secondary control output with communication to the further producers or their control apparatuses;

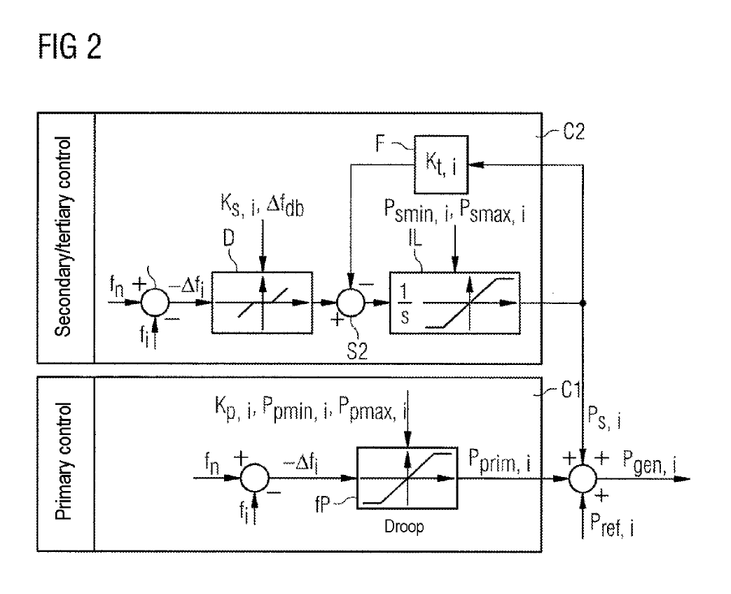

FIG. 2 shows a basic circuit diagram to explain the output control with a control apparatus according to embodiments of the present invention; and

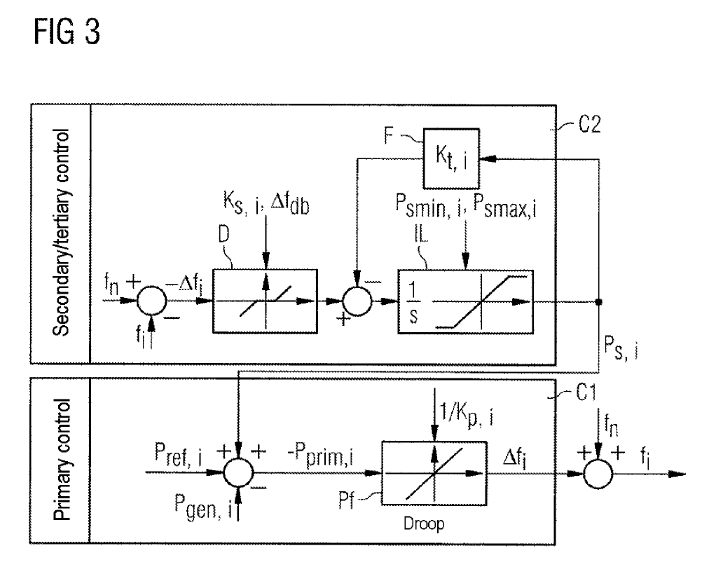

FIG. 3 shows a further basic circuit diagram to explain the frequency control with a control apparatus according to embodiments of the present invention.

### DETAILED DESCRIPTION

All control apparatuses for decentralized production of a primary and secondary/tertiary control output usually have, as illustrated in FIGS. 1 to 3, a distributed primary controller C1 for each producer for control with the aid of what is known as a “droop” and, in addition, a distributed secondary controller C2alt or C2, wherein the latter contains, as basic element, an I controller I or IL, which possibly has a limiter L.

In order to organize stable operation of AC power networks, in electrical engineering in power producers, the setting value of a “droop” is used. This element is accordingly designated by “droop” in FIG. 1. The characteristic value of the droop describes, amongst other things, for example the negative slope of the normalized characteristic curve f(P). This represents the dependence of the setpoint of the effective output P on the measured or estimated frequency f. Thus, a “droop” or controller characteristic curve is used in composite operation of many power plants to coordinate the primary control of the effective output P via the network variables as an information carrier. Here, depending on the network frequency f, the effective output P is controlled, in that, for example, in a turbine set with decreasing network frequency, the torque and therefore also the output is increased and vice versa. Base-load power plants have a high droop, peak load power plants have a low droop. A low droop means a flat f(P) characteristic curve, i.e. even extremely small frequency deviations lead to large load changing reactions (see, for example, Wikipedia “Droop speed control”.

FIG. 1 shows a basic block circuit diagram of a known control apparatus for the decentralized production of a primary and secondary control output with “explicit” communication SYNC between individual producers in a power network N. “Implicit” communication certainly takes place, so to speak via the changes in the output and frequency relationships in the network. Since the distributed integrators otherwise operate against one another in the medium term, since frequency measurements are inaccurate or the clock rates of the processors on which the secondary control is implemented are not accurately synchronized, in known systems synchronization of the respective integrator, for example here the integrator I of the distributed secondary controller C2alt, with the integrators in the control apparatuses of the further producers located in the network is carried out.

Important components of this known secondary control C2alt are the determination of the deviation Δf₁ of the locally measured or estimated frequency fᵢ from the network frequency fₙ, the amplification M of this deviation with an amplification factor K_{s,i} and the integration I of the deviation thus amplified, wherein the integrator output, for example limited by a limiter L to the two limiting values P_{smin,1}<0 and P_{smax,1}>0, supplies the respective secondary/tertiary control output P_{s/t,i} or P_{s,i} of the secondary controller C2alt, which is then supplied to the primary controller C1 to be accounted for.

In the distributed primary controller C1, first of all a determination of the deviation Δfᵢ of the locally measured or estimated frequency fᵢ from the network frequency fₙ if likewise carried out, but which is then converted with the aid of the droop, here a frequency/output characteristic curve fP, into a corresponding respective primary output P_{prim,i}, which in turn, together with the respective secondary/tertiary control output P_{s/t,i} and together with a respective reference output P_{ref,i} from the respective producer, results in a respective generator output P_{gen,i} which is to be established.

FIG. 2 shows a basic circuit diagram to explain the control of the generator output P_{gen,i} of a distributed producer in accordance with the known structure according to FIG. 1 but, instead of the known secondary control C2alt, here there is a control apparatus C2 according to embodiments of the invention for the secondary/tertiary control output.

Also in the control apparatus C2, first of all the deviation Δfᵢ of the locally measured or estimated frequency fᵢ from the network frequency fₙ is determined with the aid of a subtractor S1. After that, this deviation is amplified in an amplifier D with dead band outside a dead band Δf_{db} for values of small magnitude by an amplification factor k_{s,i} and, within the dead band, is largely suppressed to the value zero. The output from the amplifier D with dead band is connected to an input of a further subtractor S2, the output from which is connected to the input of an integrator IL with a limiter which, in addition to an integration, ensures that at the output of the integrator IL the respective secondary/tertiary control output P_{s,i} of the secondary controller C2 is limited to the two limiting values P_{smin,i}≤0 and P_{smax,i}≥0. The value of the respective secondary/tertiary control output P_{s,i}, multiplied by a respective factor k_{t,i} in a feedback unit F, is then led to the negative input of the further subtractor S2, by which means stabilizing negative feedback is achieved.

In order to prevent the gradually divergent integration of the distributed integrators, according to embodiments of the invention there is a correction element locally, which prevents continuous integration of small deviations Δfᵢ. This correction element can, for example, be implemented optionally by the feedback unit F or the dead band Δf_{db} in the amplifier D, individually or else in combination.

The feedback unit F dominates the input of the integrator with small deviations Δfᵢ and thus leads the integrator back to output values of small magnitude. The dead band Δf_{db} ensures that the output from the amplifier D is zero with small deviations Δfᵢ and thus the integrator does not integrate further. In both cases, divergent integration, e.g. on account of non-identical processor clock rates of the distributed integrators or on account of measurement errors of the frequency fᵢ, is thus prevented. Thus, it is possible to dispense with communication for avoiding the divergent integration.

FIG. 3 shows a basic circuit diagram to explain the control of the generator frequency fᵢ of a distributed producer. The control apparatus C2 described in more detail above for the secondary/tertiary control output can also be used for this purpose, wherein the secondary/tertiary control output P_{s,i} of the secondary controller C2 at the input of the primary power controller C1 is added to a respective reference output P_{ref,i} of the respective producer and, by means of subtraction of a respective generator output P_{gen,i} to be established, a negative respective primary output P_{prim,i} results, which is used as an input variable for a droop in the form of a power/frequency characteristic curve fP. With the aid of this droop, which also includes a multiplication by the factor 1/k_{p,i}, a frequency deviation Δfᵢ is formed, to which the network frequency fₙ is then added at the output and, as a result, the generator frequency fᵢ of the respective producer that is to be established is formed.

Advantages:

Scalability

The method can be used for as many producers as desired. An overload of individual participants is prevented by the saturations. The corresponding producers supply the maximum/minimum permissible secondary control output. The secondary control output required beyond the latter is provided by all the other producers which are not in saturation. The maximum/minimum available total secondary control output is thus the sum of the maximum/minimum secondary control outputs of the individual producers.

Connect and produce immediately (plug-and-produce)

New participants can enter into an existing control output pool by connecting up the “local secondary control device”, without this having to be communicated to the other participants. Only the amplifications k_{s,i} and k_{t,i} should lie in a similar order of magnitude and the dead bands Δf_{db} must be coordinated.

Robust with respect to communication failures

Since this method manages completely without explicit communication, arbitrarily long operation of the power network without communication is in principle possible. This is of great importance, in particular in emergency scenarios.

Compatibility with existing secondary control output structures

The method can be integrated into existing structures without great adjustments. A combination of central and decentralized secondary controls is easily possible. As long as the central secondary control is active, it will control the deviation of the network frequency to zero. As soon as the central secondary control fails, the decentralized secondary controls assume this task. By means of suitable selection of the amplification factors, embodiments of the invention can thus also be used as a backup solution for power networks in emergency situations.

Robustness with respect to network separation of large power networks

The method is likewise robust with respect to the separation of a large power network into a plurality of partial networks. If a partial network has sufficient primary and secondary control output to compensate for the output balance, that is the difference of production and load, in its own partial network, this compensation takes place automatically without any explicit communication between the participating producers.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A control apparatus for determining a secondary/tertiary control output of a respective decentralized producer in a power network having a multiplicity of power producers, comprising:
a subtractor that first determines a deviation the locally measured or estimated frequency from a target frequency;
an amplifier and an integrator connected in series, wherein the integrator has a correction element such that continuous integration of small deviations is prevented.

2. The control apparatus as claimed in claim 1, wherein the correction element has an amplifier with dead band.

3. The control apparatus as claimed in claim 1 wherein the correction element has a feedback unit.

4. The control apparatus as claimed in claim 3, further comprising a feedback unit such that an output from the integrator is fed back negatively to an input of the integrator, wherein a multiplication by a factor is also carried out.

5. The control apparatus as claimed in claim 1, wherein a limiter ensures that a secondary/tertiary control output formed at an output of the integrator is limited and is connected downstream of the integrator.

6. The control apparatus as claimed in claim 1, wherein the target frequency corresponds to the network frequency.

7. A method for operating a control apparatus as claimed in claim 1, the method comprising:
determining, in a distributed primary controller, a deviation of the locally measured or estimated frequency from the network frequency, which is then converted into a corresponding respective primary output with an aid of a droop in a form of a frequency/output characteristic curve and in which multiplication by a factor is carried out; and
as a result, determining a respective generator output that is to be established as a result of the fact that a reference output of the respective producer is added to the respective primary output formed in the primary controller and to the respective secondary/tertiary control output formed in the control apparatus.

8. A method for operating a control apparatus as claimed in claim 1, the method comprising:
forming a negative respective primary output, in that, at an input to the primary output controller, the secondary/tertiary control output determined in the control apparatus is added to a respective reference output of the respective producer and a respective generator output to be established is subtracted therefrom; and
utilizing the negative respective primary output as an input variable for a droop in a form of an output/frequency characteristic curve, wherein the droop also includes a multiplication by a factor and, at the output, supplies a frequency deviation, to which the network frequency is added at the output and, as a result, the generator frequency of the respective producer that is to be established is formed.
